(19) United States
(12) Patent Application Publication
(10) Pub. No.: US 2025/0242659 A1
(43) Pub. Date: Jul. 31, 2025

(54) AIRFLOW CONTROL FOR HEATING VENTILATION AND AIR CONDITIONING SYSTEMS

(71) Applicant: Rivian IP Holdings, LLC, Irvine, CA (US)

(72) Inventors: Zachary Kyle MOUL, Redondo Beach, CA (US); Ajay PANEKKAD, Laguna Niguel, CA (US); Ean Joshua HALL, Long Beach, CA (US)

(21) Appl. No.: 18/596,550

(22) Filed: Mar. 5, 2024

Related U.S. Application Data
(60) Provisional application No. 63/625,839, filed on Jan. 26, 2024.

(51) Int. Cl. B60H 1/00

(52) U.S. Cl. CPC B60H 1/00842; B60H 1/00828; B60H 1/00849

(57) ABSTRACT

Aspects of the subject disclosure relate to airflow control for heating ventilation and air conditioning (HVAC) systems, including HVAC systems for vehicles. The airflow control may include controlling a blower to provide a constant amount of airflow through an open one of multiple outlet vents, before and after a switch, between an open configuration and a closed configuration, of one or more others of the multiple outlet vents. For example, controlling the blower to provide the constant amount of airflow may include controlling the blower based at least in part on a cumulative outlet area of a set of the multiple outlet vents that are in the open configuration.

### CROSS REFERENCE TO RELATED APPLICATIONS

This application claims the benefit of priority to U.S. Provisional Patent Application No. 63/625,839, entitled, “Airflow Control for Heating Ventilation and Air Conditioning Systems”, filed on Jan. 26, 2024, the disclosure of which is hereby incorporated herein in its entirety.

### INTRODUCTION

Vehicles are often provided with heating ventilation and air conditioning (HVAC) systems.

### SUMMARY

In some HVAC systems, including vehicle HVAC systems, control parameters for a blower of the HVAC system are determined and then converted into a resulting airflow using a scaling factor. The resulting airflow may be used in downstream heat transfer computations for the HVAC system. For example, airflow in HVAC systems, such as vehicle HVAC systems, is often determined in units of Cubic Meters per Hour (CMH) for ease of use in downstream heat transfer calculations. However, this strategy of converting blower control parameters to airflow may not be accurate for many combinations of air intake door position and/or positions of front/rear air distribution doors of the HVAC system.

Aspects of the subject technology provide an improved airflow control operation based on inlet and outlet cross-sectional areas for vent pathways being used. In one or more examples, a desired airflow may be determined first, and then used to obtain one or more blower control parameters, such as a pulse width modulation (PWM) fraction or ratio for the blower, based on the inlet and/or outlet cross-sectional areas. This can result in a more accurate control of the blower, as well as more accurate airflow determination, such as for use in downstream heat transfer operations. In one or more implementations, one or more lookup tables or other functions may be provided for obtaining a blower control parameter from a desired airflow and a current outlet area of one or more outlet vents that are in an open configuration. In one or more implementations, two lookup tables can be provided, one for each of two configurations of an air inlet, such as a fresh air configuration and a recirculation configuration.

In accordance with aspects of the subject technology, an apparatus is provided that includes a blower configured to move air from an inlet to a plurality of outlet vents, each of the plurality of outlet vents switchable between an open configuration and a closed configuration; and processing circuitry configured to control the blower based at least in part on a cumulative outlet area of a set of the plurality of outlet vents that are in the open configuration. The processing circuitry may be configured to control the blower based at least in part on the cumulative outlet area of the set of the plurality of outlet vents that are in the open configuration by: determining a desired airflow for a user climate setting; determining the cumulative outlet area of the set of the plurality of outlet vents that are in the open configuration; and determining a control parameter for the blower based at least in part on the desired airflow and the outlet area.

The cumulative outlet area may be a sum of cross-sectional areas of the outlet vents in the set of the plurality of outlet vents that are in the open configuration. The processing circuitry may be further configured to determine an inlet area of the inlet. Determining the control parameter for the blower based at least in part on the desired airflow and the outlet area may include determining the control parameter for the blower based at least in part on the desired airflow, the inlet area, and the outlet area. The processing circuitry may be configured to determine the inlet area by determining whether the inlet is in a recirculation configuration or an external air configuration, and determining the control parameter for the blower based at least in part on the desired airflow, the inlet area, and the outlet area may include selecting a parameter determination mode based on the determination of whether the inlet to the blower is in the recirculation configuration or the external air configuration.

Selecting the parameter determination mode may include selecting a first lookup table if the inlet to the blower is in the recirculation configuration or a second lookup table if the inlet to the blower is in the external air configuration. Determining the control parameter for the blower based at least in part on the desired airflow, the inlet area, and the outlet area may include determining the control parameter using the selected parameter determination mode, the desired airflow, and the outlet area.

The control parameter may include a power parameter indicating an amount of power to provide to the blower to generate the desired airflow. The power parameter may include a pulse width modulation parameter. The set of the plurality of outlet vents that are in the open configuration may be located in a first zone within a passenger compartment of a vehicle, the plurality of outlet vents may include a second set that are in the closed configuration and that are located in a second zone within the passenger compartment of the vehicle, and determining the desired airflow may include performing a scaling operation based on a ratio of the cumulative outlet area of the set of the plurality of outlet vents that are in the open configuration to a cumulative outlet area of the set of the plurality of outlet vents that are in the open configuration and the second set of the outlet vents that are in the closed configuration. The first zone may be a front zone of the passenger compartment in which a driver seat is disposed, and the second zone may be a rear zone of the passenger compartment.

The plurality of outlet vents may include one or more first outlet vents in a first zone within a passenger compartment of a vehicle and one or more second outlet vents in a second zone within the passenger compartment of the vehicle, and the processing circuitry may be further configured to: determine a zonal airflow for the first zone based on the desired airflow and a ratio of a cumulative area of the one or more first outlet vents to a cumulative area of the one or more first outlet vents and the one or more second outlet vents; determine a zonal discharge temperature based at least in part on the zonal airflow; and control, based on the zonal discharge temperature, one or more aspects of a heating ventilation and air conditioning (HVAC) system including the blower, the inlet and the plurality of outlet vents.

The processing circuitry may be configured to determine the desired airflow by: determining a steady-state airflow based on the user climate setting; determining a transient airflow based on a difference between the user climate setting and a current temperature within the apparatus; determining a solar load airflow based at least on a solar load on the apparatus; and determining the desired airflow based on the steady-state airflow, the transient airflow, and the solar load airflow. The blower and the plurality of outlet vents may be implemented in a heating ventilation and air conditioning (HVAC) system. The HVAC system may be implemented in a vehicle.

In accordance with other aspects of the disclosure, a method is provided that includes determining, by processing circuitry of a vehicle, a desired airflow for a user climate setting for a passenger compartment of the vehicle; determining, by the processing circuitry, an inlet area of an air inlet to a blower of the vehicle; determining, by the processing circuitry, an outlet area of an open set of a plurality of vents in the passenger compartment of the vehicle; determining, by the processing circuitry, a control parameter for the blower based on the desired airflow, the inlet area, and the outlet area; and controlling, by the processing circuitry based on the control parameter, an airflow through the open set of the plurality of vents with the blower.

The method may also include detecting, by the processing circuitry, a change from the open set of the plurality of vents to a different open set of the plurality of vents due to one or more openings or a closings of one or more of the plurality of vents; determining, by the processing circuitry, a new outlet area for the different open set of the plurality of vents; determining, by the processing circuitry, an updated control parameter for the blower based on the desired airflow, the inlet area, and the new outlet area; and controlling, by the processing circuitry, airflow through the different open set of the plurality of vents with the blower based on the updated control parameter.

The method may also include detecting, by the processing circuitry, a change in a configuration of the air inlet; determining, by the processing circuitry, an updated control parameter for the blower based on the desired airflow, the change in the configuration of the air inlet, and the outlet area; and controlling, by the processing circuitry, airflow through the open set of the plurality of vents with the blower based on the updated control parameter. Determining the control parameter for the blower based on the desired airflow, the inlet area, and the outlet area may include: selecting a first lookup table based on the inlet area of the air inlet, and determining the control parameter using the first lookup table, the desired airflow, and the outlet area. Determining the updated control parameter for the blower based on the desired airflow, the change in the configuration of the air inlet, and the outlet area may include: selecting a second lookup table based on the change in the configuration of the air inlet, and determining the control parameter using the second lookup table, the desired airflow, and the outlet area.

In accordance with other aspects of the disclosure, a vehicle is provided that includes a blower; a plurality of vents, each switchable between an open configuration and a closed configuration, and each configured to outlet air received from the blower in the open configuration; and processing circuitry configured to control the blower to provide a constant amount of airflow through an open one of the plurality of vents before and after a switch of one or more others of the plurality of vents between the open configuration and the closed configuration. The vehicle may also include an inlet for the blower, and the processing circuitry may be further configured to control the blower to provide the constant amount of airflow through the open one of the plurality of vents before and after a change in a configuration of the inlet. The change in the configuration of the inlet may include change between a recirculation configuration and an external air configuration.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having one or more vents in accordance with one or more implementations.

FIG. 2A illustrates a schematic top view of a vehicle having vents in accordance with one or more implementations.

FIG. 2B illustrates an example user interface for controlling an HVAC system of a vehicle in accordance with one or more implementations.

FIG. 3 illustrates a schematic diagram of a processing architecture for controlling a blower of a heating ventilation and air conditioning (HVAC) system in accordance with one or more implementations.

FIG. 4 illustrates a schematic diagram of a processing flow for an airflow determination block in accordance with one or more implementations.

FIG. 5 illustrates a schematic diagram of a processing flow for a control signal determination block in accordance with one or more implementations.

FIG. 6 illustrates a schematic diagram of a processing flow for control signal determination block with zonal scaling in accordance with one or more implementations.

FIG. 7 illustrates a flow chart of illustrative operations that may be performed for controlling a blower in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Apparatuses, such as vehicles, buildings, and/or other enclosed and/or indoor spaces are often provided with ventilation systems, such as heating ventilation and air conditioning (HVAC) systems. Ventilation systems often include a blower or other air-moving component configured to move air from one or more inlets to one or more outlet vents. One or more of the outlet vents may be switchable between an open configuration and a closed configuration, such as by a user to control the flow of air at various locations and/or within various zones within the apparatus (e.g., various locations and/or zones within a passenger compartment of a vehicle).

Changing the inlet and/or the outlet vent configurations can result in a change to the airflow within the apparatus if, for example, the blower operation is not modified. This can result in too much or too little airflow for a given climate setting, and can produce a change in airflow that is noticeable to a user.

Aspects of the subject technology can provide airflow control that accounts for changes in the configuration of the inlet and/or the outlet vents, as described in further detail hereinafter.

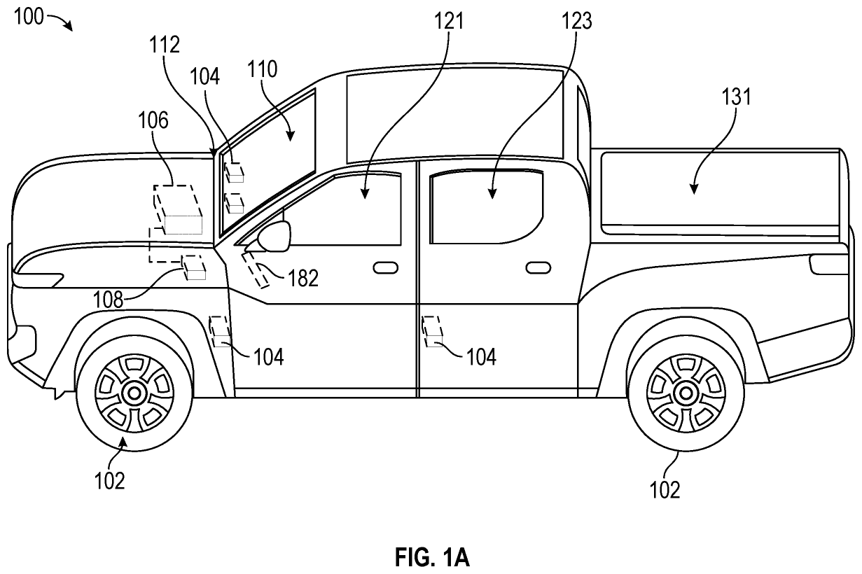

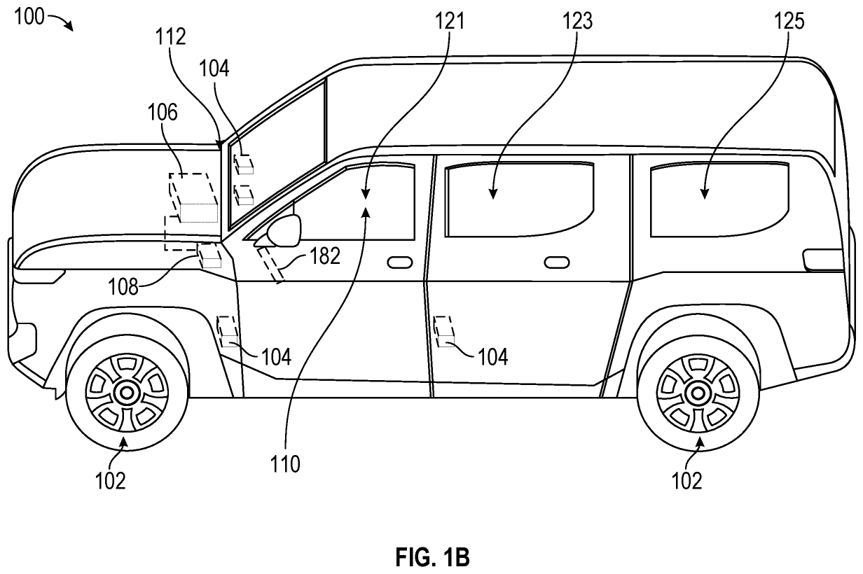

FIG. 1A is a diagram illustrating an example implementation of an apparatus as described herein. In the example of FIG. 1A, the apparatus is a moveable apparatus implemented as a vehicle 100. In one or more implementations, the vehicle 100 may be implemented as an electric vehicle and may include one or more batteries for powering the vehicle and/or one or more systems and/or components of the vehicle.

For example, in one or more implementations, the vehicle 100 may be an electric vehicle having one or more electric motors that drive the wheels 102 of the vehicle using electric power from the battery. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a ventilation system (e.g., an HVAC) system. For example, the vehicle 100 (e.g., the HVAC system of the vehicle) may include a blower 106 and one or more outlet vents 104. As shown, the vehicle 100 may also include processing circuitry 108 (e.g., one or more processors, memory, and/or communications circuitry). The processing circuitry 108 may be communicatively coupled to the blower 106, for control, by the processing circuitry 108, of the blower 106 (e.g., to control an amount of power that is provided to the blower 106, such as from a battery of the vehicle 100).

As shown, the vehicle 100 may include multiple outlet vents 104 (e.g., also referred to herein as vents) within a passenger compartment 110 of the vehicle 100. As shown, the vents 104 may include vents that are disposed in a front portion 121 of the passenger compartment 110, a rear portion 123 of the passenger compartment 110, and/or other portions of the passenger compartment 110. The outlet vents 104 may include face vents or dash-mounted vents, floor vents, defrost vents, side vents, and/or other vents.

The blower 106, or another air-moving component, may be configured to move air from an inlet 112 (e.g., an external inlet at or near the base of the windshield or elsewhere on the exterior of the vehicle, and/or an internal (recirculation) inlet on or near a dashboard within the passenger compartment 110 of the vehicle or elsewhere within the passenger compartment 110 of the vehicle) to the one or more outlet vents 104. The inlet 112 may be switchable from a fresh air configuration or external air configuration (e.g., in which air is pulled into the inlet 112 from outside the vehicle) to a recirculation configuration (e.g., in which air is pulled into the inlet 112 from within the passenger compartment 110 of the vehicle).

As examples, the processing circuitry 108 of the vehicle 100 may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine-readable media (e.g., persistent storage, system memory and/or buffers, volatile memory and/or non-volatile memory). In one or more implementations, the processing circuitry 108 may include input devices, output devices, network interfaces, and/or a bus that communicatively couples the processor(s), the memory, the communications circuitry, the input devices, the output devices, and/or one or more other devices or components (e.g., blower 106, cameras, motion sensors, proximity sensors, etc.). The processor(s) of the processing circuitry 108 may execute instructions stored in the memory of the processing circuitry 108, such as to execute hardware, firmware, and/or software processes in order to perform the processes of the subject disclosure.

As shown in FIG. 1A, the vehicle 100 may include a control panel 182 (e.g., a touchscreen control panel). The control panel 182 of the vehicle 100 may be communicatively coupled to the processing circuitry 180, and may provide controls (e.g., buttons, knobs, switches, and/or a touch-screen user interface) for operating various components and/or features of the vehicle 100 (e.g., climate control, audio control, etc.).

The example of FIG. 1A, in which the vehicle 100 is implemented as a pickup truck having a truck bed 131, is merely illustrative. For example, FIG. 1B illustrates another implementation in which the vehicle 100 including the outlet vents 104, the blower 106, the processing circuitry 108, and the inlet 112 is implemented as a sport utility vehicle (SUV), such as an electric sport utility vehicle. In the example of FIG. 1B, the vehicle 100 including the outlet vents 104, the blower 106, the processing circuitry 108, and the inlet 112 may include a cargo storage area 125 and/or a third row of seats in at least a rear portion of the vehicle that is enclosed within the passenger compartment 110 the vehicle 100 (e.g., behind a row of seats within a cabin of the vehicle). In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having outlet vents 104, a blower 106, processing circuitry 108, and an inlet 112.

In one or more implementations, the outlet vents 104, the blower 106, the processing circuitry 108, and the inlet 112 as described herein may also, or alternatively, be implemented in another apparatus, such as a building (e.g., a residential home or commercial building, or any other building) or other stationary apparatus.

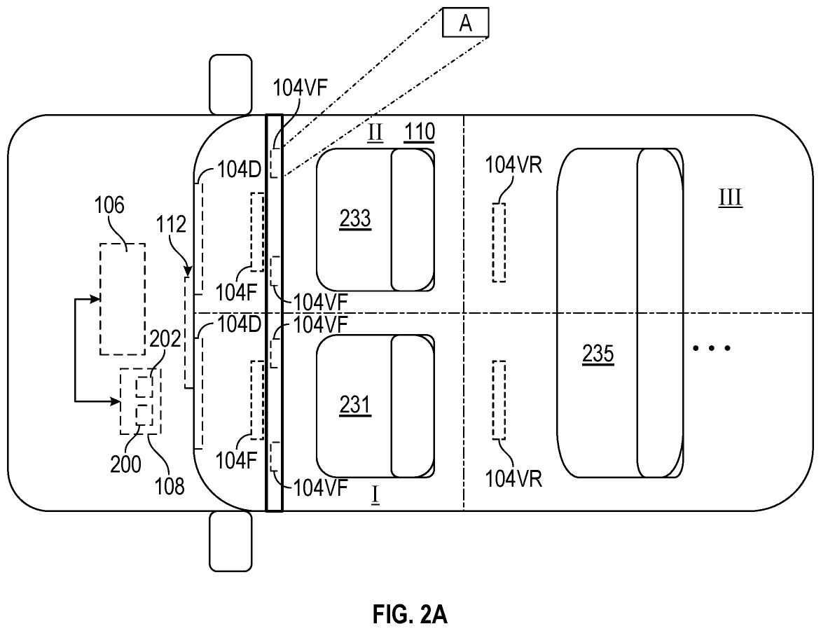

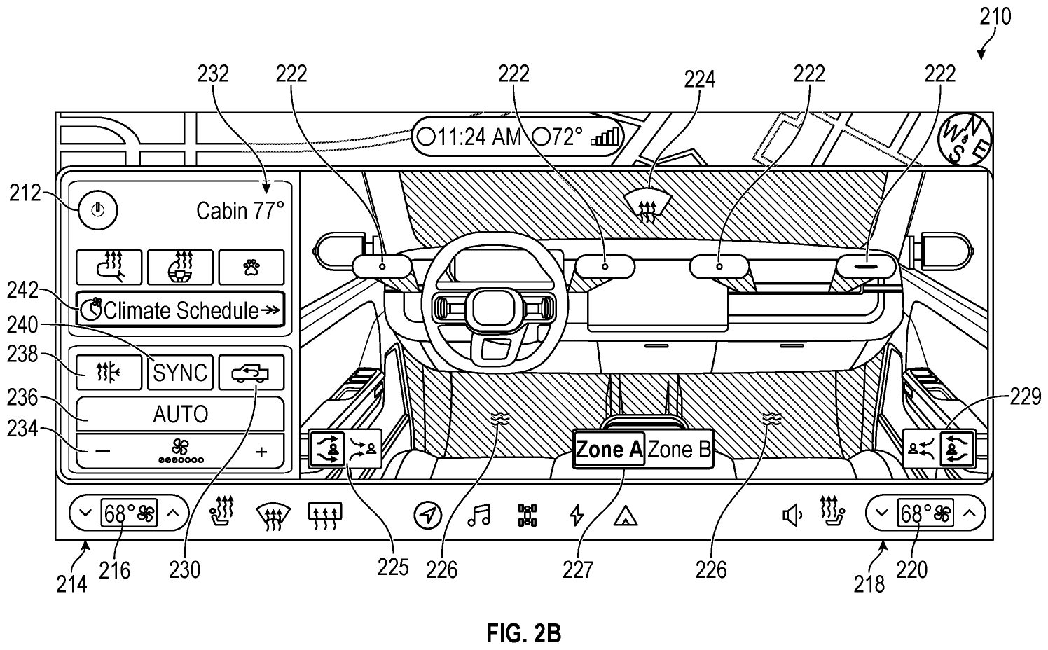

FIG. 2A depicts a schematic top view of the vehicle 100 in accordance with one or more implementations. As shown in FIG. 2A, the outlet vents 104 may include one or more face vents 104VF (also referred to as dash-mounted vents), one or more floor vents 104F, one or more defrost vents 104D, and/or one or more rear vents 104VR. As shown, the rear vents 104VR may be located in a rear zone III (e.g., corresponding to the rear portion 123 of FIGS. 1A or 1B) of the passenger compartment 110 (e.g., for providing airflow for passengers in a rear seat of the vehicle 100). For example, the rear zone III may include one or more rows of rear passenger seats 235. As shown, the face vents 104VF may include one or more (e.g., multiple) face vents in each of one or more front zones (e.g., a driver zone I in which a driver seat 231 is disposed and/or a passenger zone II in which a passenger seat 233, such as a front passenger seat is disposed) of the passenger compartment 110. As shown, the floor vents 104F may include one or more (e.g., multiple) floor vents in each of the one or more front zones (e.g., the driver zone I and/or the passenger zone II) of the passenger compartment 110. As shown, the defrost vents 104D may include one or more (e.g., multiple) defrost vents in each of the one or more front zones (e.g., the driver zone I and/or the passenger zone II) of the passenger compartment 110. As indicated in FIG. 2A, each vent 104 (e.g., each of the face vents 104VF, the floor vents 104F, the defrost vents 104D, and the rear vents 104VR) may have a respective area, A, such as a cross-sectional area across the opening of the vent to the passenger compartment. Although a single area, A, is depicted in FIG. 2A, it is appreciated that each vent may have its own cross-sectional area, and thus its own corresponding value of the area, A.

In one or more implementations, some or all of the outlet vents 104 (e.g., some or all of the face vents 104VF, the floor vents 104F, the defrost vents 104D, and/or the rear vents 104VR) may be switchable between an open configuration and a closed configuration. In the open configuration, a vent 104 may be open to allow airflow generated by the blower 106 to flow through that vent into the passenger compartment 110. In the closed configuration, a vent 104 may be closed to prevent airflow generated by the blower 106 from flowing through that vent into the passenger compartment 110. The vents 104 may be switchable between binary fully open (e.g., with an outlet area, A) and fully closed (e.g., with an outlet area of zero) configuration, or may be controllable to (e.g., smoothly) adjust the area of the outlet vent to areas. A′, between the fully open area, A, and the zero area of the closed vent.

As described herein, the inlet 112 may be switchable between an external air inlet and a recirculation input. The external air inlet and the recirculation inlet may have different inlet areas. In one or more implementations, the processing circuitry 108 may select between different parameter determination modes for controlling the blower 106, based on the inlet area of the inlet 112 (e.g., based on whether the inlet 112 is switched to the external air inlet or the recirculation inlet), as described in further detail hereinafter. For example, the processing circuitry 108 (e.g., memory of the processing circuitry 108) may store multiple computation blocks and/or lookup tables that can be selected for determining control parameters for the blower based on the inlet area.

As one illustrative example, the processing circuitry 108 may store multiple lookup tables (e.g., a first lookup table 200 and a second lookup table 202) that can be selected for parameter determination based on the inlet area of the inlet 112. For example, the first lookup table 200 may be selected if the inlet 112 to the blower 106 is in the recirculation configuration or the second lookup table 202 may be selected if the inlet to the blower is in the external air configuration. Each of the lookup tables may provide, for a given cumulative outlet area of a set of open outlet vents 104, a conversion between a desired airflow (e.g., in Cubic Meters per Hour (CMH)) to a corresponding blower power (e.g., a blower PWM) to achieve that airflow through the open set of outlet vents 104.

For simplicity of the figure, the blower 106, the inlet 112, and the various outlet vents 104 are shown in FIG. 2A without showing ducting therebetween for routing airflow from the inlet 112 to the blower 106, and from the blower 106 to the various outlet vents 104. However, it is appreciated that ducting may be provided between the inlet 112 and the blower 106, and between the blower 106 and the various outlet vents 104, such that airflow generated by the blower 106 causes air to flow into the blower 106 from the inlet 112 and air to flow from the blower 106 to the various outlet vents 104.

FIG. 2B illustrates an example user interface (UI) 210 that may be provided by a vehicle, such as the vehicle 100, in accordance with one or more implementations. For example, the user interface 210 may be displayed by the control panel 182, which may be implemented as a touch-screen interface that allows a user (e.g., an occupant of the vehicle 100, such as a driver or a passenger) to interact with various user control elements in the user interface 210 (e.g., to provide various instructions to the processing circuitry 108 for controlling various aspects of the HVAC system of the vehicle 100).

In the example of FIG. 2B, the user control elements of the UI 210 include an on/off icon 212 (e.g., for switching the HVAC system of the vehicle on and off), a temperature control icon 214 for setting a user climate setting such as user temperature 216 (e.g., a driver-side or zone I temperature, and/or a vehicle-wide or all-zone temperature), a temperature control icon 218 for setting a user climate setting such as user temperature 220 (e.g., a passenger-side temperature or zone II temperature), a recirculation icon 230 (e.g., for switching the inlet 112 between an external air inlet and a recirculation input), and/or one or more vent control elements for opening and/or closing one or more of the vents 104 of the vehicle 100. For example, the vent control elements may include one or more face-vent control icons 222 (e.g., for opening and/or closing one or more of the face vents 104VF, such as by tapping or otherwise touching one or more of the face-vent control icons 222), one or more defrost control icons 224 (e.g., for opening and/or closing one or more of the defrost vents 104D, such as by tapping or otherwise touching one or more of the defrost control icons 224), and/or one or more floor-vent control icons 226 (e.g., for opening and/or closing one or more of the floor vents 104F, such as by tapping or otherwise touching one or more of the floor-vent control icons 226).

In one or more implementations, the vent control elements of the UI 210 may also include one or more control icons for selecting (e.g., setting in an open configuration) one or more sets, or groups, of the vents 104. For example, a control icon 225 may be provided for selecting the face vents 104VF or selecting the defrost vents 104D and floor vents 104F (and/or selecting the face vents 104VF and the floor vents 104F) in a particular zone (e.g., zone I, such as a driver zone) of the vehicle 100. As another example, a control icon 229 may be provided for selecting the face vents 104VF or selecting the defrost vents 104D and floor vents 104F (and/or selecting the face vents 104VF and the floor vents 104F) in another particular zone (e.g., zone II, such as a passenger zone) of the vehicle 100. In one or more implementations, a zone selection icon 227 may be provided in the user interface 210. For example, the zone selection icon 227 may be provided for selecting (e.g., opening) all of the vents in a particular zone (e.g., zone I, zone II, or zone III of FIG. 2A) or for selecting a set of vent control icons to be displayed in the UI 210. For example, the zone selection icon 227 may be used to toggle between displaying vent control icons for a first zone (e.g., Zone A, such as the driver zone I, the passenger zone II, or all front zones, such as both the driver zone I and passenger zone II, of the vehicle) and the vent control icons for second zone (e.g., Zone B, such as a rear zone III) of the vehicle.

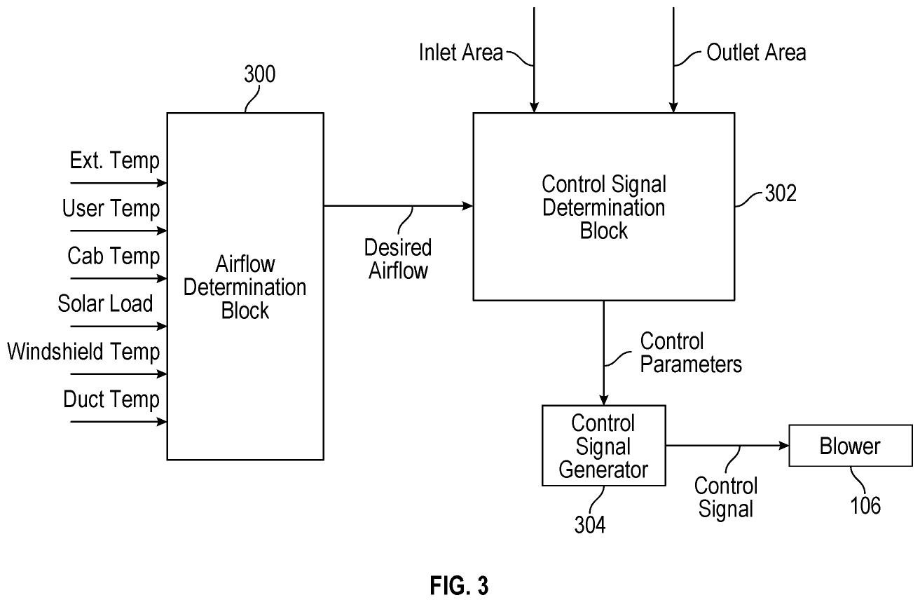

As shown, a current cab temperature 232 may also be displayed in the user interface 210. As shown in FIG. 2B, the user interface 210 may include other control elements, such as an air-conditioning icon 238 for switching between a heating mode and an air-conditioning mode, a “sync” icon 240 for synchronizing the temperature and/or other climate settings of the passenger zone(s) (e.g., zone II and/or zone III) to the driver-side zone (e.g., zone I), a fan-control element 234 for manually increasing or decreasing an amount of airflow, and/or an “auto” icon 236 for instructing the processing circuitry 108 to automatically control the airflow of the HVAC system (e.g., through an open set of vents 104), such as using the systems and processes described herein (e.g., in connection with FIGS. 3-7). The user interface 210 may also include a scheduler icon 242, which can be used, for example, to set a schedule of desired user temperatures and/or vent configurations for the vehicle 100, such as at one or more future times and/or within one or more future time windows.

FIG. 3 illustrates a schematic diagram of a processing architecture for controlling a blower of a heating ventilation and air conditioning (HVAC) system in accordance with one or more implementations. As illustrated in FIG. 3, an apparatus, such as a vehicle, may control a blower 106 by determining (e.g., by an airflow determination block 300, which may be executed by the processing circuitry 108) a desired airflow (e.g., in Cubic Meters per Hour (CMH)) for a user climate setting (e.g., a desired temperature, such as the user temperature 216 or 220, set by a user, such as a driver or passenger, such as using the temperature control icon 214 and/or the temperature control icon 218) for a passenger compartment 110 of the vehicle. As shown, the desired airflow may be determined based on an external temperature, a user temperature (e.g., the user climate setting), a cab temperature 232 (e.g., a measured temperature within the passenger compartment 110), a solar load, a windshield temperature, one or more duct outlet temperatures, and/or one or more other inputs.

For example, the external temperature may be measured using a temperature sensor (e.g., a thermometer or thermistor) that is exposed to the air outside the vehicle 100. For example, the user temperature may be a user climate setting that is set by an occupant (e.g., a driver or a passenger) interacting with a user interface (e.g., a button, a knob, a switch, a dial, a touchscreen, or the like) within the vehicle. For example, the cab temperature may be measured using a temperature sensor (e.g., a thermometer or thermistor) that is exposed to the air inside the passenger compartment 110 of the vehicle 100. For example, the solar load may be measured by one or more irradiance sensors (e.g., pyranometers) on an exterior surface of the vehicle and/or within the vehicle. The solar load may be a directly measured solar load or may be a solar load for a vehicle occupant that is derived from one or more directly measured solar loads (e.g., and/or other information, such as a known location of the vehicle, a geometry or layout of the passenger compartment and/or windows of the vehicle, and/or time of day or time of year). For example, the windshield temperature may be measured using a temperature sensor (e.g., a thermometer or thermistor) that is thermally coupled to a windshield of the vehicle 100. For example, the duct temperature may be measured using a temperature sensor (e.g., a thermometer or thermistor) that is exposed to the air flowing from one of the outlet vents 104 and/or within a duct of the HVAC system. In some implementations, one or more of the external temperature, the cab temperature, the solar load, the windshield temperature, the duct temperature, and/or other temperatures in or around the vehicle 100 may be derived based on one or more others of the external temperature, the cab temperature, the solar load, the windshield temperature, or the duct temperature (e.g., and/or other information, such as the result of a heat transfer rate equation analysis as described hereinafter).

The apparatus (e.g., processing circuitry 108) may also determine an inlet area of an air inlet (e.g., inlet 112) to a blower 106 of the vehicle. The apparatus (e.g., processing circuitry 108) may also determine an outlet area (e.g., A, A′) of an open set of multiple vents (e.g., outlet vents 104) in the passenger compartment of the vehicle. In one or more implementations, an outlet area may be determined for the open set of multiple vents, and an area of a closed set of multiple vents (and/or an area of all vents) may also be determined, such as for zonal scaling operations as described herein.

As shown in FIG. 3, the apparatus (e.g., a control signal determination block 302, which may be executed by the processing circuitry 108) may determine a control parameter (e.g., a power parameter, such as a pulse-width modulation (PWM) parameter) for the blower 106 based on the desired airflow, the inlet area, and the outlet area. As shown, the apparatus (e.g., a control signal generator 304, which may be implemented in, or controlled by, the processing circuitry 108) may control, based on the control parameter, an airflow through the open set of the multiple vents with the blower (e.g., be providing a control signal to the blower 106 from the control signal generator 304).

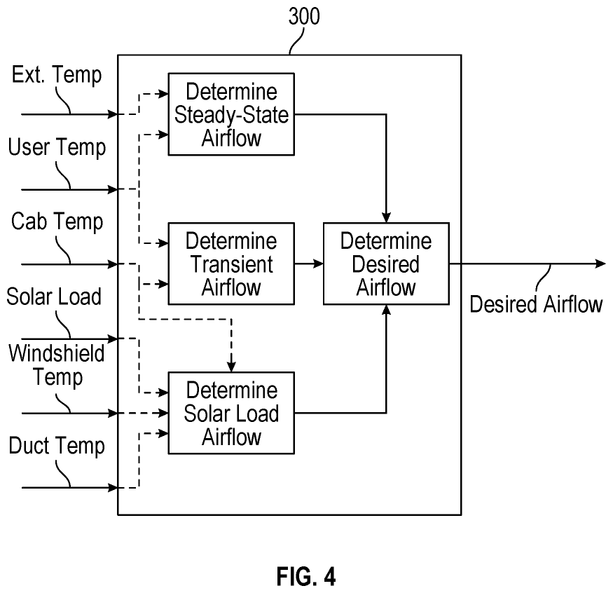

FIG. 4 illustrates a schematic diagram of a processing flow for the airflow determination block 300, in accordance with one or more implementations. As shown, the airflow determination block 300 may determine the desired airflow by: determining a desired steady-state airflow based on the user climate setting (e.g., a user temperature) and/or other information such as an external temperature of an external environment of the vehicle; determining a desired transient airflow based on a difference between the user climate setting and a current temperature within the apparatus (e.g., a cab temperature); determining a desired solar load airflow based a solar load on the apparatus, a windshield temperature, a duct outlet temperature, and/or a cab temperature; and determining the desired airflow based on the steady-state airflow, the transient airflow, and the solar load airflow (e.g., by combining, such as summing or averaging, the steady-state airflow, the transient airflow, and the solar load airflow).

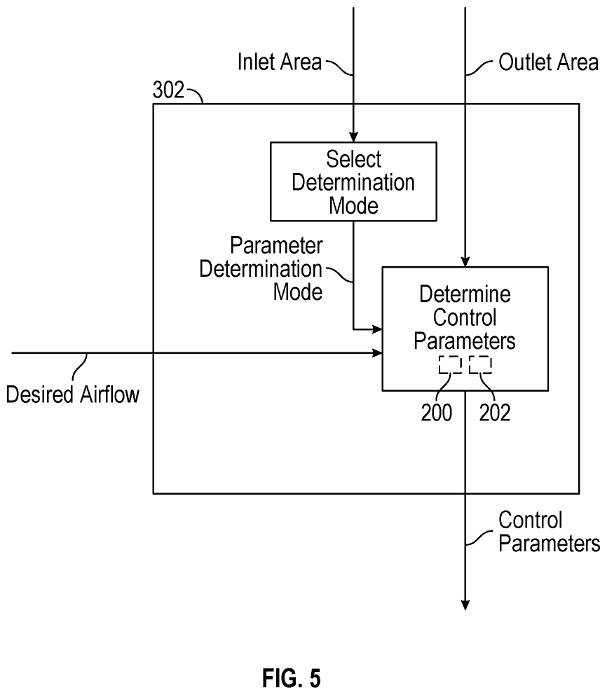

FIG. 5 illustrates a schematic diagram of a processing flow for a control signal determination block in accordance with one or more implementations. As shown in FIG. 5, determining a control parameter for the blower 106 based on the desired airflow, the inlet area, and the outlet area may include, by the control signal determination block 302: selecting a first lookup table based on the inlet area of the air inlet (e.g., selecting first lookup table 200, if the air inlet is in a recirculation configuration), and determining the control parameter using the first lookup table, the desired airflow, and the outlet area.

In various use cases, a user (e.g., a driver or a passenger in the vehicle 100) may change the configuration of the outlet vents 104 (e.g., by opening and/or closing one or more of the outlet vents 104) and/or the inlet 112 (e.g., by switching between the recirculation configuration and the external air configuration). In one or more implementations, the processing circuitry 108 may use an updated cumulative outlet area of the open vents and/or a different lookup table based on the change to the inlet 112, to maintain a constant amount of airflow through any of the vents that are open before and after the change in configuration.

For example, the processing circuitry 108 may detect a change in the open set of the multiple vents, to a different open set of the multiple vents, due to one or more openings or a closings of one or more of the multiple vents. Detecting the change in the open set of vents may include detecting a change resulting from a user (e.g., an occupant, such as a driver or a passenger) physically modifying one or more vent doors, or may include receiving and processing a user input to a user interface within the vehicle, the user input including an instruction to electronically modify the position(s) of one or more vent doors). Responsively to detecting the change in the open set of vents, the processing circuitry 108 may determine a new outlet area for the different open set of the multiple vents; determine (e.g., by the control signal determination block 302) an updated control parameter for the blower 106 based on the desired airflow (e.g., the previously determined desired airflow, as the change in outlet vent configuration may not change the desired airflow), the inlet area, and the new outlet area; and control (e.g., by the control signal generator 304) airflow through the different open set of the multiple vents with the blower 106 based on the updated control parameter.

As another example, the processing circuitry 108 may detect a change in a configuration of the air inlet (e.g., a switch of the inlet 112 between a recirculation configuration and an external air configuration). Detecting the change in the configuration of the air inlet may include detecting a change resulting from a user (e.g., an occupant, such as a driver or a passenger) physically modifying a vent door of the air inlet, or may include receiving a user input to a user interface within the vehicle, the user input including an instruction to electronically modify the vent door of the air inlet). Responsively to detecting the change in the configuration of the air inlet, the processing circuitry 108 (e.g., the control signal determination block 302) may determine an updated control parameter for the blower 106 based on the desired airflow, the change in the configuration of the air inlet, and the outlet area. The processing circuitry 108 (e.g., the control signal generator 304) may control airflow through the open set of the multiple vents with the blower 106 based on the updated control parameter. For example, determining the updated control parameter for the blower based on the desired airflow, the change in the configuration of the air inlet, and the outlet area may include: selecting a second lookup table (e.g., second lookup table 202, if the change is to an external air configuration) based on the change in the configuration of the air inlet, and determining the control parameter using the second lookup table, the desired airflow, and the outlet area.

As illustrated by the example of FIG. 5, in one or more implementations, once a desired airflow is determined (e.g., by the airflow determination block 300, such as is described in connection with FIG. 4), a lookup table with an outlet cross-sectional area axis and a desired airflow axis may be used to lookup the blower control parameter(s). As discussed herein, there may be two of these lookup tables, one for a fresh air configuration of the inlet 112 and one for a recirculation configuration of the inlet 112. In one or more implementations, a weighted average based on the current intake door position may be applied. In one or more implementations, the outlet cross-sectional areas in the lookup tables 200 and 202 may correspond to one more HVAC modes (e.g., floor vents only, defrost only, face vents only, maximum cooling, maximum heating, automatic, etc.).

In one or more other implementations, the outlet cross-sectional areas in the lookup tables 200 and 202 may correspond to every possible combination of the inlet 112 and the outlet vents 104. In one or more other implementations, a simulation may be performed to determine the airflow resistance of each duct to create a resistance model. However, these other implementations may involve, for example, a large simulation processes to test each inlet and outlet door combination. Such a simulation could be run and rerun overnight; however, these operations may be relatively long and computationally expensive processes. For these reasons, it may be beneficial to use lookup tables 200 and 202 as described herein (e.g., for various HVAC modes), as this method is more accurate than a simple scaling conversion and involves less time and computational effort than testing or simulating each inlet and outlet mode combination. Additionally, computing the airflow and looking of the blower control parameters based on outlet area allows for the total airflow to be calculated then accurately split in to driver, passenger, and rear zones, based on the outlet area for each zone (e.g., which may be more accurate than splitting zones by a fixed percentage).

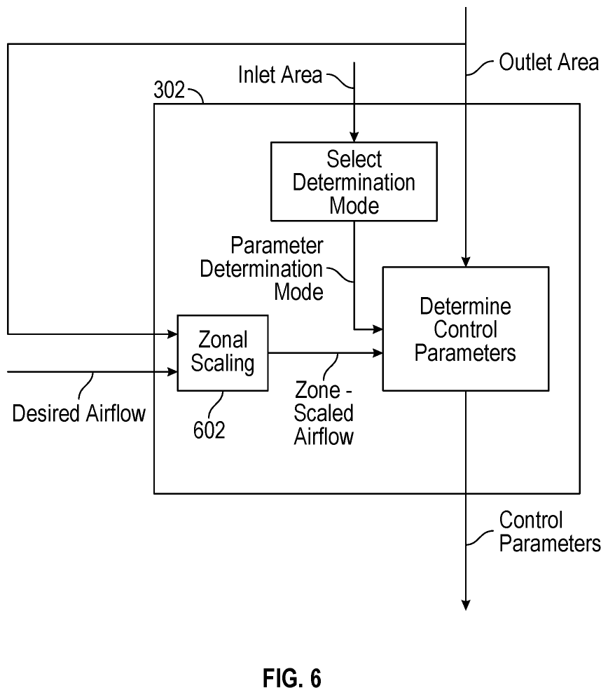

FIG. 6 illustrates a schematic diagram of a processing flow for control signal determination block with zonal scaling in accordance with one or more implementations. In one or more implementations, the determination of the desired airflow by the airflow determination block 300 of FIG. 3 may be based on equations and/or algorithms that depend on at least some of the determined desired airflow occurring in multiple (e.g., all) zones of a passenger compartment of a vehicle (e.g., in both front and rear zones of the passenger compartment 110, and/or in both a driver zone I and a passenger zone II of the passenger compartment 110). However, in one or more use cases, all of the outlet vents 104 in one or more zones of the vehicle may be closed. In these use cases, a zonal scaling operation 602 may be performed to scale the desired airflow to account for the closing of all of the outlet vents 104 in the one or more zones of the vehicle. For example, the zonal scaling operation may multiply a zonal scaling factor with the desired airflow to obtain a zone-scaled airflow. The zonal scaling factor may be, for example, a ratio of the cumulative area of the vents in the zone in which the vents are open, to the cumulative area of all vents (including the vents in the zone in which the vents are closed). The zonal scaling operation 602 may be applied to the total desired airflow determined by the airflow determination block 300, or to a component (e.g., the steady-state airflow) of the airflow determined by the airflow determination block 300.

In one or more implementations, the zonal scaling operation may also, or alternatively, be used to estimate the current airflow through a particular one of the outlet vents 104 and/or the outlet vents 104 in a particular zone within the vehicle 100. For example, the zonal scaling factor for a particular zone (e.g., the ratio of the cumulative area of the vents in a zone to the cumulative area of all vents in all zones) may be applied to the total airflow through the blower 106 to estimate the airflow in that particular zone. This estimated zonal airflow may then be used, for example, as the mass flow value (m or m_dot) in the heat transfer rate equation Q=m Cp dT or, for a particular zone in the vehicle 100, Q_zone=m_dot_zone*Cp*(T_discharge_zone−T_evap), where Q_zone is the heat transfer rate for that particular zone, Cp is the specific heat capacity (e.g., of air), T_discharge_zone is the discharge temperature in that zone, and T_evap is the temperature at the evaporator). In some implementations, because Q_zone and T_evap are measurable and Cp is a known constant, estimating m_dot_zone using the total desired airflow and the zonal scaling parameter may allow an estimation of the discharge temperature T_discharge_zone in the particular zone (e.g., without having or using a temperature sensor in that zone). This estimated temperature can be used to control other aspects of the vehicle and/or the HVAC system, such as the heater core or a cooling element, such as a refrigerant compressor. Determining zonal discharge temperatures in this way may provide a framework for temperature estimation without the use of (e.g., or with reduced use of) physical temperature sensors, which may result in efficiencies in terms of vehicle cost, weight, and/or manufacturing complexity.

Any of the various processing blocks and/or operations of FIGS. 3-6 may be implemented in hardware, firmware, software, and/or any combination of hardware, firmware, and software.

As illustrated by FIGS. 1A-6, an apparatus (e.g., vehicle 100) may be provided that includes a blower 106 configured to move air from an inlet 112 to multiple outlet vents 104, each of the multiple outlet vents 104 switchable between an open configuration and a closed configuration; and processing circuitry 108 configured to control the blower 106 based at least in part on a cumulative outlet area of a set of the multiple outlet vents 104 that are in the open configuration. For example, the blower and the multiple outlet vents 104 may be implemented in a heating ventilation and air conditioning (HVAC) system. For example, the HVAC system may be implemented in a vehicle, such as vehicle 100.

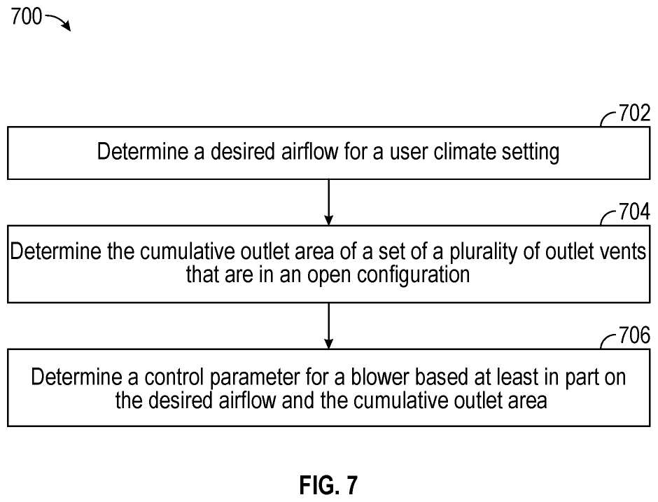

FIG. 7 illustrates a flow diagram of an example process for operating a ventilation system, in accordance with implementations of the subject technology. For explanatory purposes, the process 700 is primarily described herein with reference to the vehicle 100, the outlet vents 104, the blower 106, the inlet 112, and the processing circuitry 108 of FIGS. 1A-6. However, the process 700 is not limited to the vehicle 100, the vehicle 100, the outlet vents 104, the blower 106, the inlet 112, and the processing circuitry 108 of FIGS. 1A-6, and one or more blocks (or operations) of the process 700 may be performed by one or more other components of other suitable apparatuses, devices, or systems. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 700, at block 702, a desired airflow may be determined (e.g., by the airflow determination block 300) for a user climate setting. For example, the user climate setting may be a desired temperature provided by a user, via a user interface of the vehicle 100, to the processing circuitry 108. In one or more implementations, determining the desired airflow may include determining a steady-state airflow based on the user climate setting (e.g., based on the user climate a setting and an external temperature); determining a transient airflow based on a difference between the user climate setting and a current temperature within the apparatus; determining a solar load airflow based at least on a solar load on the apparatus (e.g., and/or based on one or more of a windshield temperature, cabin temperature, and/or duct outlet temperature); and determining the desired airflow based on the steady-state airflow, the transient airflow, and the solar load airflow (e.g., as illustrated in FIG. 4).

At block 704, a cumulative outlet area of a set of a plurality of outlet vents (e.g., outlet vents 104) that are in an open configuration may be determined (e.g., by the processing circuitry 108). For example, the cumulative outlet area may be a sum of cross-sectional areas of the outlet vents in the set of the plurality of outlet vents that are in the open configuration. For example, determining the cumulative outlet area may include identifying which of the plurality of outlet vents are in the open configuration, obtaining (e.g., looking up) an area (e.g., a cross-sectional area, such as a current cross-sectional area in the current open configuration, such as a fully open area, A, or a partially open area, A′, between A and zero) of each of the outlet vents identified to be in the open configuration, and summing the obtained areas of the outlet vents identified to be in the open configuration. In one or more implementations, the processing circuitry 108 may pre-store cumulative areas for multiple (e.g., a subset or all) possible combinations of open vents.

At block 706, a control parameter may be determined for the blower (e.g., by the control signal determination block 302) based at least in part on the desired airflow and the outlet area (e.g., as illustrated in FIGS. 3, 5, and/or 6). For example, the control parameter may include a power parameter indicating an amount of power to provide to the blower to generate the desired airflow. For example, the power parameter may include a pulse width modulation (PWM) parameter (e.g., a PWM fraction or ratio).

In one or more implementations, the process 700 may also include determining (e.g., by the processing circuitry 108) an inlet area of the inlet. Determining the control parameter for the blower based at least in part on the desired airflow and the outlet area at block 706 may include determining the control parameter for the blower based at least in part on the desired airflow, the inlet area, and the outlet area (e.g., as illustrated in FIGS. 3, 5, and/or 6). In one or more implementations, determining the inlet area may include determining whether the inlet is in a recirculation configuration or an external air configuration. Determining the control parameter for the blower based at least in part on the desired airflow, the inlet area, and the outlet area may include selecting a parameter determination mode based on the determination of whether the inlet to the blower is in the recirculation configuration or the external air configuration (e.g., as illustrated in FIG. 5). For example, selecting the parameter determination mode may include selecting a first lookup table 200 if the inlet to the blower is in the recirculation configuration or a second lookup table 202 if the inlet to the blower is in the external air configuration. In one or more implementations, determining the control parameter for the blower based at least in part on the desired airflow, the inlet area, and the outlet area may include determining the control parameter using the selected parameter determination mode, the desired airflow, and the outlet area (e.g., as illustrated in FIG. 5). For example, determining the control parameter using the selected parameter determination mode, the desired airflow, and the outlet area may include obtaining the control parameter from the lookup table at a location in the lookup table that corresponds to both the desired airflow and the cumulative outlet area.

In one or more implementations, the set of the plurality of outlet vents that are in the open configuration may be located in a first zone (e.g., driver zone I, passenger zone II, or a front zone including the driver zone and the passenger zone) within a passenger compartment (e.g., passenger compartment 110) of a vehicle (e.g., vehicle 100). The plurality of outlet vents may include a second set of outlet vents that are in the closed configuration and that are located in a second zone (e.g., rear zone III) within the passenger compartment of the vehicle. In one or more implementations, determining the desired airflow may include performing a scaling operation (e.g., a zonal scaling operation 602, as illustrated in FIG. 6) based on a ratio of the cumulative outlet area of the set of the plurality of outlet vents that are in the open configuration to a cumulative outlet area of the set of the plurality of outlet vents that are in the open configuration and the second set of the outlet vents that are in the closed configuration. For example, the first zone may be a front zone (e.g., driver zone I, passenger zone II, or a front zone including the driver zone and the passenger zone) of the passenger compartment in which a driver seat 231 is disposed, and the second zone may be a rear zone of the passenger compartment.

In one or more implementations, the plurality of outlet vents may include one or more first outlet vents in a first zone (e.g., driver zone I, passenger zone II, or a front zone including the driver zone and the passenger zone) within a passenger compartment (e.g., passenger compartment 110) of a vehicle (e.g., vehicle 100) and one or more second outlet vents in a second zone (e.g., rear zone III) within the passenger compartment of the vehicle. The process 700 may also include determining (e.g., by the processing circuitry 108) a zonal airflow for the first zone based on the desired airflow and a ratio of a cumulative area of the one or more first outlet vents to a cumulative area of the one or more first outlet vents and the one or more second outlet vents; determining a zonal discharge temperature based at least in part on the zonal airflow; and controlling, based on the zonal discharge temperature, one or more aspects (e.g., a heater core or a refrigerant compressor) of a heating ventilation and air conditioning (HVAC) system including the blower, the inlet and the plurality of outlet vents.

As illustrated by FIGS. 1A-7, a vehicle 100 may be provided that includes a blower; multiple vents (e.g., outlet vents 104), each switchable between an open configuration and a closed configuration, and each configured to outlet air received from the blower 106 in the open configuration; and processing circuitry 108 configured to control the blower 106 to provide a constant amount of airflow through an open one of the multiple vents before and after a switch of one or more others of the multiple vents between the open configuration and the closed configuration. For example, the vehicle 100 may also include an inlet 112 for the blower 106. The processing circuitry 108 may be further configured to control the blower 106 to provide the constant amount of airflow through the open one of the plurality of vents before and after a change in a configuration of the inlet. For example, the change in the configuration of the inlet may include change between a recirculation configuration and an external air configuration.

For example, in one or more use cases, a user may change an intake door of the inlet 112 from external (e.g., fresh) air to a recirculation configuration, and the processing circuitry 108 may decrease the blower (e.g., based on selecting the power parameter for the blower from a different lookup table, such as the first lookup table 200, rather than from the second lookup table 202 used in the external air configuration) to maintain the current airflow through the open outlet vents 104. As another example, in one or more use cases, a user may change an intake door of the inlet 112 from the recirculation configuration to the external (e.g., fresh) air configuration, and the processing circuitry 108 may increase the blower (e.g., based on selecting the power parameter for the blower from a different lookup table, such as the second lookup table 202, rather than from the first lookup table 200 used in the recirculation configuration) to maintain the current airflow through the open outlet vents 104.

As another example, in one or more use cases, a user may switch a set of open outlet vents 104 from just the face vents 104VF to the face vents 104VF and the floor vents 104F, and the processing circuitry 108 may decrease the blower (e.g., based on an increased cumulative area of the open vents), such as to maintain the current airflow through the face vents 104VF. As another example, in one or more use cases, a user may switch a set of open outlet vents 104 from the outlet vents 104 in the driver zone I, the passenger zone II, and the rear zone III to just the outlet vents 104 in the driver zone I and the passenger zone II (e.g., by closing off the rear vents), and the processing circuitry 108 may decrease the blower (e.g., based on the decreased cumulative area of the open vents and the zonal scaling operation 602), such as to maintain the current airflow through the outlet vents in the driver zone I and the passenger zone II after the transition.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus, comprising:
a blower configured to move air from an inlet to a plurality of outlet vents, wherein each of the plurality of outlet vents is switchable between an open configuration and a closed configuration; and
processing circuitry configured to control the blower based at least in part on a cumulative outlet area of a set of the plurality of outlet vents that are in the open configuration.

2. The apparatus of claim 1, wherein the processing circuitry is configured to control the blower based at least in part on the cumulative outlet area of the set of the plurality of outlet vents that are in the open configuration by:
determining a desired airflow for a user climate setting;
determining the cumulative outlet area of the set of the plurality of outlet vents that are in the open configuration; and
determining a control parameter for the blower based at least in part on the desired airflow and the outlet area.

3. The apparatus of claim 2, wherein the cumulative outlet area is a sum of cross-sectional areas of the outlet vents in the set of the plurality of outlet vents that are in the open configuration.

4. The apparatus of claim 2, wherein the processing circuitry is further configured to determine an inlet area of the inlet, wherein determining the control parameter for the blower based at least in part on the desired airflow and the outlet area comprises determining the control parameter for the blower based at least in part on the desired airflow, the inlet area, and the outlet area.

5. The apparatus of claim 4, wherein the processing circuitry is configured to determine the inlet area by determining whether the inlet is in a recirculation configuration or an external air configuration, and wherein determining the control parameter for the blower based at least in part on the desired airflow, the inlet area, and the outlet area comprises selecting a parameter determination mode based on the determination of whether the inlet to the blower is in the recirculation configuration or the external air configuration.

6. The apparatus of claim 5, wherein selecting the parameter determination mode comprises selecting a first lookup table if the inlet to the blower is in the recirculation configuration or a second lookup table if the inlet to the blower is in the external air configuration.

7. The apparatus of claim 5, wherein determining the control parameter for the blower based at least in part on the desired airflow, the inlet area, and the outlet area comprises determining the control parameter using the selected parameter determination mode, the desired airflow, and the outlet area.

8. The apparatus of claim 2, wherein the control parameter comprises a power parameter indicating an amount of power to provide to the blower to generate the desired airflow.

9. The apparatus of claim 8, wherein the power parameter comprises a pulse width modulation parameter.

10. The apparatus of claim 2, wherein the set of the plurality of outlet vents that are in the open configuration are located in a first zone within a passenger compartment of a vehicle, wherein the plurality of outlet vents includes a second set that are in the closed configuration and that are located in a second zone within the passenger compartment of the vehicle, and wherein determining the desired airflow comprises performing a scaling operation based on a ratio of the cumulative outlet area of the set of the plurality of outlet vents that are in the open configuration to a cumulative outlet area of the set of the plurality of outlet vents that are in the open configuration and the second set of the outlet vents that are in the closed configuration.

11. The apparatus of claim 10, wherein the first zone is a front zone of the passenger compartment in which a driver seat is disposed, and the second zone is a rear zone of the passenger compartment.

12. The apparatus of claim 2, wherein the plurality of outlet vents comprises one or more first outlet vents in a first zone within a passenger compartment of a vehicle and one or more second outlet vents in a second zone within the passenger compartment of the vehicle, and wherein the processing circuitry is further configured to:
determine a zonal airflow for the first zone based on the desired airflow and a ratio of a cumulative area of the one or more first outlet vents to a cumulative area of the one or more first outlet vents and the one or more second outlet vents;
determine a zonal discharge temperature based at least in part on the zonal airflow; and
control, based on the zonal discharge temperature, one or more aspects of a heating ventilation and air conditioning (HVAC) system comprising the blower, the inlet and the plurality of outlet vents.

13. The apparatus of claim 2, wherein the processing circuitry is configured to determine the desired airflow by:
determining a steady-state airflow based on the user climate setting;
determining a transient airflow based on a difference between the user climate setting and a current temperature within the apparatus;
determining a solar load airflow based at least on a solar load on the apparatus; and
determining the desired airflow based on the steady-state airflow, the transient airflow, and the solar load airflow.

14. The apparatus of claim 1, wherein the blower and the plurality of outlet vents are implemented in a heating ventilation and air conditioning (HVAC) system.

15. The apparatus of claim 14, wherein the HVAC system is implemented in a vehicle.

16. A method, comprising:
determining, by processing circuitry of a vehicle, a desired airflow for a user climate setting for a passenger compartment of the vehicle;
determining, by the processing circuitry, an inlet area of an air inlet to a blower of the vehicle;
determining, by the processing circuitry, an outlet area of an open set of a plurality of vents in the passenger compartment of the vehicle;
determining, by the processing circuitry, a control parameter for the blower based on the desired airflow, the inlet area, and the outlet area; and
controlling, by the processing circuitry based on the control parameter, an airflow through the open set of the plurality of vents with the blower.

17. The method of claim 16, further comprising:
detecting, by the processing circuitry, a change from the open set of the plurality of vents to a different open set of the plurality of vents due to one or more openings or a closings of one or more of the plurality of vents;
determining, by the processing circuitry, a new outlet area for the different open set of the plurality of vents;
determining, by the processing circuitry, an updated control parameter for the blower based on the desired airflow, the inlet area, and the new outlet area; and
controlling, by the processing circuitry, airflow through the different open set of the plurality of vents with the blower based on the updated control parameter.

18. The method of claim 16, further comprising:
detecting, by the processing circuitry, a change in a configuration of the air inlet;
determining, by the processing circuitry, an updated control parameter for the blower based on the desired airflow, the change in the configuration of the air inlet, and the outlet area; and
controlling, by the processing circuitry, airflow through the open set of the plurality of vents with the blower based on the updated control parameter.

19. The method of claim 18, wherein determining the control parameter for the blower based on the desired airflow, the inlet area, and the outlet area comprises:
selecting a first lookup table based on the inlet area of the air inlet, and
determining the control parameter using the first lookup table, the desired airflow, and the outlet area; and
wherein determining the updated control parameter for the blower based on the desired airflow, the change in the configuration of the air inlet, and the outlet area comprises:
selecting a second lookup table based on the change in the configuration of the air inlet, and
determining the control parameter using the second lookup table, the desired airflow, and the outlet area.

20. A vehicle, comprising:
a blower;
a plurality of vents, each switchable between an open configuration and a closed configuration, and each configured to outlet air received from the blower in the open configuration; and
processing circuitry configured to control the blower to provide a constant amount of airflow through an open one of the plurality of vents before and after a switch of one or more others of the plurality of vents between the open configuration and the closed configuration.

21. The vehicle of claim 20, further comprising an inlet for the blower, wherein the processing circuitry is further configured to control the blower to provide the constant amount of airflow through the open one of the plurality of vents before and after a change in a configuration of the inlet.

22. The vehicle of claim 21, wherein the change in the configuration of the inlet comprises change between a recirculation configuration and an external air configuration.
